(19) United States
(12) Patent Application Publication
(10) Pub. No.: US 2025/0193828 A1
(43) Pub. Date: Jun. 12, 2025

(54) METHOD AND APPARATUS FOR CONTROLLING TIMER, COMMUNICATION DEVICE, AND STORAGE MEDIUM

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/842,451

(22) PCT Filed: Mar. 2, 2022
(86) PCT No.: PCT/CN2022/078830

§ 371 Date: Aug. 29, 2024

(51) Int. Cl. H04W 64/00; H04W 60/04; H04W 84/06

(52) U.S. Cl. CPC H04W 64/00; H04W 60/04; H04W 84/06

(57) ABSTRACT

A method, apparatus and computer readable storage medium for controlling a timer that is used in a wireless communication system. The timer is controlled by: determining, according to satellite coverage information, a satellite signal coverage result of an area where the UE is located in response to determining that an update timer times out; and determining, according to the satellite signal coverage result of the area where the UE is located, whether to restart the update timer.

### CROSS-REFERENCE TO RELATED APPLICATIONS

The present application is a U.S. National Stage of International Application No. PCT/CN2022/078830, filed on Mar. 2, 2022, the contents of all of which are incorporated herein by reference in their entirety for all purposes.

### BACKGROUND OF THE INVENTION

Registration updates may be performed periodically by user equipment (UE) according to an update timer. Registration updates is mainly used for a network device to inform the UE that the network device is in a state of access to a network.

The update timer is maintained in the UE. When the update timer expires (that is, it times out), a registration update request is initiated to a network side by the UE, so that the UE and the network device enter a registration update process.

### SUMMARY OF THE INVENTION

The disclosure relates to, but is not limited to, the technical field of wireless communications, in particular to a method and an apparatus for controlling a timer, a communication device, and a storage medium.

A first aspect of the examples of the disclosure provides a method for controlling a timer, performed by a user equipment (UE), including:
determining, according to satellite coverage information, a satellite signal coverage result of an area where the UE is located in response to determining that an update timer times out; and
determining, according to the satellite signal coverage result of the area where the UE is located, whether to restart the update timer.

A second aspect of the examples of the disclosure provides a method for controlling a timer, performed by a first network element, including:
determining, according to satellite coverage information, a satellite signal coverage result of an area where UE is located in response to determining that a mobile reachable timer times out; and
determining, according to the satellite signal coverage result of the area where the UE is located, whether to restart the mobile reachable timer.

A fifth aspect of the examples of the disclosure provides a communication device, including a processor, a transceiver, a memory, and an executable program stored on the memory and capable of being operated by the processor, where the method for controlling a timer provided by the above first aspect or second aspect is performed when the executable program is executed by the processor.

A sixth aspect of the examples of the disclosure provides a computer storage medium, storing an executable program, where after the executable program is executed by a processor, the method for controlling a timer provided by the above first aspect or second aspect can be implemented.

It is to be understood that the above general descriptions and later detailed descriptions are merely examples and illustrative, and cannot limit the examples of the disclosure.

### BRIEF DESCRIPTION OF DRAWINGS

Accompanying drawings here are incorporated into the specification, constitute a part of the specification, and show principles consistent with examples of the disclosure and used together with the specification for explaining the examples of the disclosure.

FIG. 1 is a schematic structural diagram of a wireless communication system illustrated according to an example.

FIG. 2A is a schematic flowchart of a method for controlling a timer illustrated according to an example.

FIG. 2B is a schematic flowchart of a method for controlling a timer illustrated according to an example.

FIG. 2C is a schematic flowchart of a method for controlling a timer illustrated according to an example.

FIG. 3 is a schematic flowchart of an information processing method illustrated according to an example.

FIG. 4 is a schematic flowchart of a method for controlling a timer illustrated according to an example.

FIG. 5A is a schematic flowchart of a method for controlling a timer illustrated according to an example.

FIG. 5B is a schematic flowchart of a method for controlling a timer illustrated according to an example.

FIG. 5C is a schematic flowchart of a method for controlling a timer illustrated according to an example.

FIG. 6 is a schematic flowchart of a method for controlling a timer illustrated according to an example.

FIG. 7 is a schematic flowchart of an information processing method illustrated according to an example.

FIG. 8 is a schematic flowchart of a method for controlling a timer illustrated according to an example.

FIG. 9 is a schematic structural diagram of an apparatus for controlling a timer illustrated according to an example.

FIG. 10 is a schematic structural diagram of an apparatus for controlling a timer illustrated according to an example.

FIG. 11 is a schematic structural diagram of UE illustrated according to an example.

FIG. 12 is a schematic structural diagram of a communication device illustrated according to an example.

### DETAILED DESCRIPTION OF THE INVENTION

Examples will be illustrated in detail here, and their instances are shown in accompanying drawings. When the following description refers to the accompanying drawings, unless otherwise indicated, the same numbers in different accompanying drawings indicate the same or similar elements. Implementations described in the following examples do not represent all implementations consistent with examples of the disclosure. Rather, they are merely instances of apparatuses and methods consistent with some aspects of the examples of the disclosure as detailed in the appended claims.

Terms used in the examples of the disclosure are merely for the purpose of describing specific examples, and are not intended to limit the examples of the disclosure. Singular forms “a,” “an,” and “the” used in the examples of the disclosure and the appended claims are also intended to include plural forms unless other meanings be clearly indicated in context. It is also to be understood that a term “and/or” as used here refers to and contains any or all possible combinations of one or more associated listed items.

It is to be understood that although terms first, second, third, etc. may be used for describing various information in the examples of the disclosure, such information is not to be limited to these terms. These terms are merely used for distinguishing the same type of information from each other. For example, without departing from the scope of the examples of the disclosure, first information may also be referred to as second information, and similarly, the second information may also be referred to as the first information. Depending on the context, for example, a word “if” as used here may be interpreted as “at the time” or “when” or “in response to determining.”

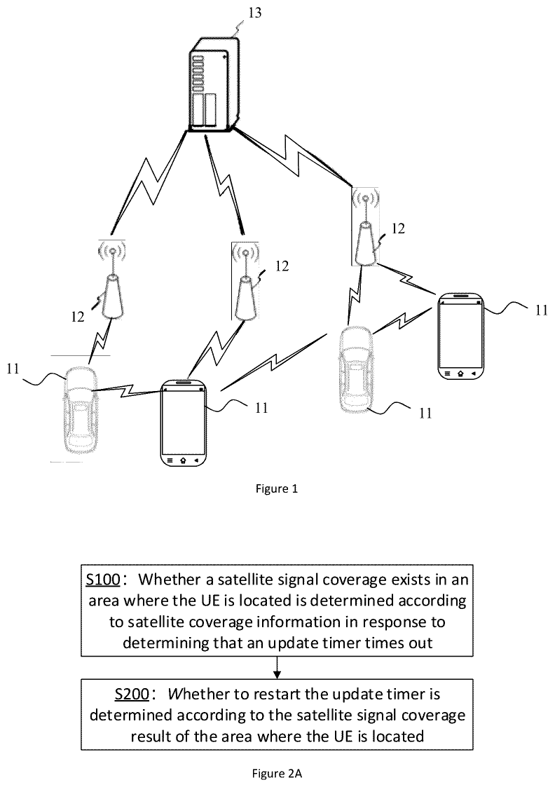

Referring to FIG. 1, it shows a schematic structural diagram of a wireless communication system provided by an example of the disclosure. As shown in FIG. 1, the wireless communication system is a communication system based on a cellular mobile communication technology. The wireless communication system may include: a plurality of UEs 11 and a plurality of access devices 12.

The UE 11 may refer to devices that provide a user with voice and/or data connectivity. The UE 11 may communicate with one or more core networks via a radio access network (RAN). The UE 11 may be internet of things UE, such as sensor devices, mobile phones (or called “cellular” phones), and computers with internet of things UE. For example, the UE may be fixed, portable, pocket-size, handheld, computer built-in or vehicle-mounted apparatuses. For example, the UE may be a station (STA), a subscriber unit, a subscriber station, a mobile station, a mobile, a remote station, an access point, remote UE (remote terminal), access UE (access terminal), a user terminal, a user agent, a user device, or user equipment (UE). Or, the UE 11 may also be unmanned aircraft devices. Or, the UE 11 may also be vehicle-mounted devices, such as a trip computer with a wireless communication function, or a wireless communication device connected with an external trip computer. Or, the UE 11 may also be roadside devices, such as a street lamp, a signal light or other roadside devices with wireless communication functions.

The access devices 12 may be network side devices in the wireless communication system. The wireless communication system may be the 4th generation mobile communication (4G) system, also called a long term evolution (LTE) system; or, the wireless communication system may also be a 5G system, also called a new radio (NR) system or 5G NR system. Or, the wireless communication system may also be a next-generation system of the 5G system. An access network in the 5G system may be called a new generation-radio access network (NG-RAN). Or, it is an MTC system.

The access devices 12 may be evolved access devices (eNB) adopted in the 4G system. Or, the access devices 12 may also be access devices adopting centralized and distributed architectures (gNB) in the 5G system. When the access devices 12 adopt the centralized and distributed architectures, they typically each include a central unit (CU) and at least two distributed units (DUs). Protocol stacks of a packet data convergence protocol (PDCP) layer, a radio link control (RLC) layer, and a media access control (MAC) layer are set in the central unit. A protocol stack of a physical (PHY) layer is set in the distributed unit. Specific implementations of the access devices 12 are not limited by the example of the disclosure.

The access devices 12 and the UE 11 may establish wireless connection through wireless radio. In different implementations, the wireless radio is wireless radio based on the 4th generation mobile communication (4G) standard; or, the wireless radio is wireless radio based on the 5th generation mobile communication (5G) standard, such as new radio; or, the wireless radio may also be wireless radio based on the next-generation mobile communication standard of 5G.

In some examples, the UE 11 may also establish an end to end (E2E) connection, for example, vehicle to vehicle (V2V) communication, vehicle to infrastructure (V2I) communication and vehicle to pedestrian (V2P) communication in vehicle to everything (V2X) communication and other scenarios.

In some examples, the wireless communication system above may further include a network management device 13.

The plurality of access devices 12 are connected with the network management device 13 respectively. The network management device 13 may be a core network device in the wireless communication system, for example, the network management device 13 may be a mobility management entity (MME) in an evolved packet core (EPC). Or, the network management device may also be other core network devices, such as a serving gate way (SGW), a public data network gate way (PGW), a policy and charging rules function (PCRF) or a home subscriber server (HSS). An implementation form of the network management device 13 is not limited in the examples of the disclosure.

With the registration of the network as a non-terrestrial network (NTN), an area where the UE is located may be in a discontinuous coverage scenario due to a motion of a satellite to the Earth. The discontinuous coverage scenario here refers to that in the area where the UE is located, the satellite signal coverage sometimes exists and sometimes there is no satellite signal coverage. This condition of discontinuous coverage may be caused by a fact that the number of satellites in Starlink is not enough to fully cover all areas within a geographical range to be covered at a moment.

Examples of the disclosure provide a method and an apparatus for controlling a timer, a communication device, and a storage medium.

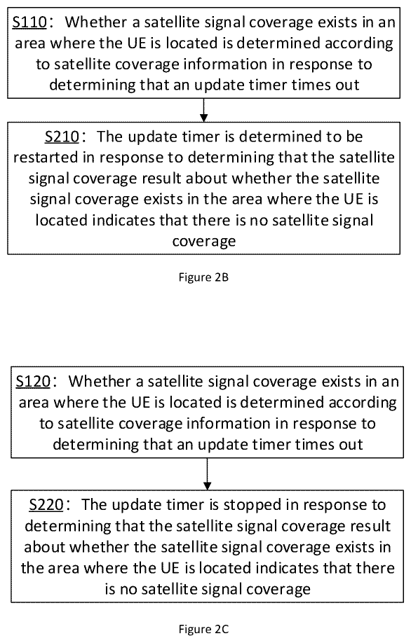

As shown in FIG. 2A, an example of the disclosure provides a method for controlling a timer, performed by an UE, including:
S100: a satellite signal coverage result of an area where the UE is located is determined according to satellite coverage information in response to determining that an update timer times out; and
S200: whether to restart the update timer is determined according to the satellite signal coverage result of the area where the UE is located.

In the technical solutions provided by the examples of the disclosure, when the update timer times out, the UE does not directly stop the update timer and initiate a registration update request, but determines, according to the satellite coverage information, whether there is satellite signal coverage in the area where the UE is currently located, and restarts or stops the update timer according to a determination result, so that the update timer may be restarted when there is no satellite signal coverage in the area where the UE is currently located, that is, the registration update request is not initiated, thus signaling overhead and power consumption overhead generated by unnecessary registration updates are reduced, and a failure probability of the registration updates is reduced.

The UE in this example may be a variety of terminal devices. The terminal devices include, but are not limited to: mobile phones, tablet computers, wearable devices, vehicle-mounted devices, smart home devices or smart office devices, etc.

In some examples, the area where the UE is located may include at least one of:
an NTN cell where the UE is located;
a TA where the UE is located;
a set of cells where the UE is located, where the set of cells includes: a cell where the UE is located and at least one adjacent cell of the cell where the UE is located; or
a set of TAs where the UE is located, where the set of TAs may include: a TA where the UE is located and at least one adjacent TA of the TA where the UE is located.

The update timer may also be referred to as a periodic registration update timer. When the UE changes from a connected state (e.g., 5GMM-CONNECTED) to an idle state (e.g., 5GMM-IDLE), the update timer needs to be started. When the UE enters into the connected state or a deregistered state (e.g., 5GMM-DEREGISTERED) from another state, the update timer is stopped.

In some examples, the UE receives information of the update timer from a network side and/or determines the information of the update timer according to a protocol agreement. The information of the update timer may at least indicate a timing duration of the update timer.

In some examples, the satellite coverage information may be used for determining a period with satellite signal coverage and/or without satellite signal coverage in the area where the UE is located.

After the update timer is started, the update timer may expire or time out.

A determination result obtained by S100 may include that: satellite signal coverage exists in the area where the UE is located and/or there is no satellite signal coverage in the area where the UE is located.

In the example of the disclosure, the UE determines, according to the satellite coverage information, whether there is satellite signal coverage in the area where the UE is currently located. If there is no satellite signal coverage in the area where the UE is currently located, the update timer is restarted by the UE in order to suppress a registration update process triggered by a timeout of the update timer. If there is no satellite signal coverage in the area where the UE is located, the registration update process is still executed to initiate a registration update request, which results in a failure of the registration update of the UE, so for the UE, there will be a high failure rate of registration updates. In the example of the disclosure, UE does not stop the update timer and initiate the registration update request when there is no satellite signal coverage, so that a failure probability of registration updates of the UE is reduced, and a success rate of updates of the UE is increased.

As shown in FIG. 2B, an example of the disclosure provides a method for controlling a timer, performed by an UE, including:
S110: a satellite signal coverage result of an area where the UE is located is determined according to satellite coverage information in response to determining that an update timer times out; and
S210: the update timer is determined to be restarted in response to determining that the satellite signal coverage result of the area where the UE is located indicates that there is no satellite signal coverage, that is, the update timer is determined to be restarted in response to determining that there is no satellite signal coverage in the area where the UE is located.

As shown in FIG. 2C, an example of the disclosure provides a method for controlling a timer, performed by an UE, including:
S120: a satellite signal coverage result of an area where the UE is located is determined according to satellite coverage information in response to determining that an update timer times out; and
S220: the update timer is stopped in response to determining that the satellite signal coverage result of the area where the UE is located indicates that satellite signal coverage exists, that is, the update timer is stopped in response to determining that the satellite signal coverage exists in the area where the UE is located.

A stop of the update timer here means that the update timer is not restarted.

For example, S220 may further include that: when the update timer is not restarted, the update timer is stopped, and a registration update request is initiated.

The UE in this example may be a variety of terminal devices. The terminal devices include, but are not limited to: mobile phones, tablet computers, wearable devices, vehicle-mounted devices, smart home devices or smart office devices, etc.

In some examples, the area where the UE is located may include at least one of: an NTN cell where the UE is located;
a TA where the UE is located;
a set of cells where the UE is located, where the set of cells includes: a cell where the UE is located and at least one adjacent cell of the cell where the UE is located; or
a set of TAs where the UE is located, where the set of TAs may include: a TA where the UE is located and at least one adjacent TA of the TA where the UE is located.

The update timer may also be referred to as a periodic registration update timer. When the UE changes from a connected state (e.g., 5GMM-CONNECTED) to an idle state (e.g., 5GMM-IDLE), the update timer needs to be started. When the UE enters into the connected state or a deregistered state (e.g., 5GMM-DEREGISTERED) from another state, the update timer is stopped.

In some examples, the UE receives information of the update timer from a network side and/or determines the information of the update timer according to a protocol agreement. The information of the update timer may at least indicate a timing duration of the update timer.

In some examples, the satellite coverage information may be used for determining a period with satellite signal coverage and/or without satellite signal coverage in the area where the UE is located.

After the update timer is started, the update timer may expires or times out, in the example of the disclosure, the UE determines, according to the satellite coverage information, whether there is satellite signal coverage in the area where the UE is currently located. If there is no satellite signal coverage in the area where the UE is currently located, the update timer is restarted by the UE in order to suppress a registration update process triggered by a timeout of the update timer. If there is no satellite signal coverage in the area where the UE is located, the registration update process is still executed to initiate a registration update request, which results in a failure of the registration update of the UE, so for the UE, there will be a high failure rate of registration updates. In the example of the disclosure, UE does not stop the update timer and initiate the registration update request when there is no satellite signal coverage, so that a failure probability of registration updates of the UE is reduced, and a success rate of updates of the UE is increased.

Restarting the update timer limited by S210 may include at least one of:
a first value is determined according to the satellite coverage information, and the update timer is restarted according to the first value, where the timing duration of the restarted update timer is the first value; in this case, the first value may be equal or unequal to a second value; the second value here may be an original value of the update timer, and the original value may be a value of the timing duration indicated by a network side; and the first value may be a temporary value determined according to the satellite coverage information;
the update timer is restarted according to the second value; or
the update timer is restarted according to a pre-agreed restart timing duration. The restart timing duration may be determined by the network side according to the satellite coverage information, or may be an agreed default timing duration.

In summary, there are a plurality of modes to restart the update timer, and a specific implementation is not limited to any of the above examples. By restarting the update timer, an operating state of the update timer is maintained, so that sending of a registration update request triggered by a timeout of the update timer is avoided.

In addition, when it is detected that the satellite signal coverage exists in an area where the UE is currently located, the update timer is stopped. Once the update timer is stopped, the registration update process is initiated automatically by the UE. If the registration update process is initiated, the registration update request is sent to the network side by the UE. Since the satellite signal coverage exists in the area where the UE is currently located, successful sending of the registration update request may be ensured, so that a success rate of registration updates of the UE is increased.

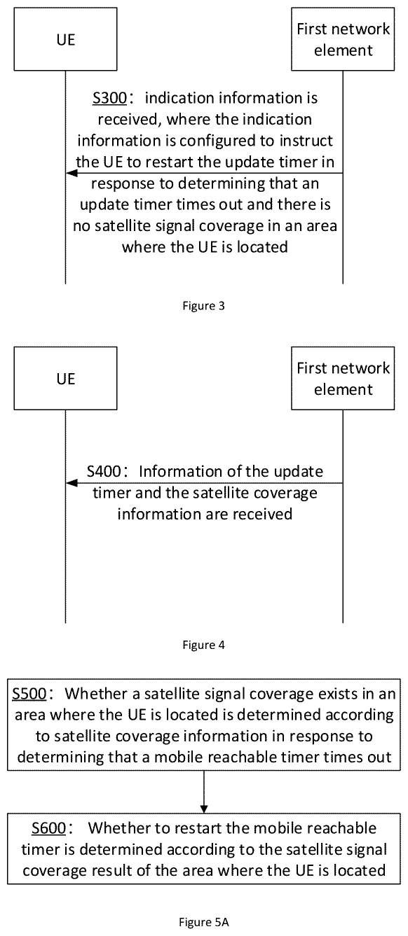

As shown in FIG. 3, an example of the disclosure provides an information processing method, performed by an UE, including:
S300: indication information is received, where the indication information is configured to instruct the UE to restart the update timer in response to determining that an update timer times out and there is no satellite signal coverage in an area where the UE is located.

The information processing method may be performed alone or in combination with the method for controlling a timer provided by any of the above examples.

For example, the indication information is sent by a network side through various signaling. The indication information is configured to instruct the UE to restart the update timer according to there is no satellite signal coverage in an area where the UE is currently located when the update timer is maintained by the UE times out in order to reduce failures of registration updates.

The indication information may be configured to instruct the UE to restart the update timer when it is detected that the update timer times out and there is no satellite signal coverage in an area where the UE is located. How to restart the update timer may be determined by the UE itself, or determined in accordance with a protocol, or determined in accordance with an agreement between the UE and a base station.

In one example, the indication information configured to instruct the UE to redetermine the first value of the timing duration of update timer according to the satellite coverage information, and restart the update timer according to the first value in response to determining that the update timer times out and there is no satellite signal coverage in the area where the UE is located.

In another example, the indication information configured to instruct the UE to restart the update timer according to a second value indicated by information of the update timer in response to determining that the update timer times out and the area where the UE is located has no satellite signal coverage.

In some examples, as shown in FIG. 4, the method further includes:
S400: information of the update timer and the satellite coverage information are received;
where information of the update timer is configured to determine the second value.

The information of the update timer and the satellite coverage information may both be sent by a network device, for example, a base station and/or an AFM on the network side.

The information of the update timer may be at least configured to determine the timing duration of the update timer by the UE.

For example, the information of the update timer may at least include a value of the timing duration, and/or time information of a start moment and an end moment for timing of the update timer.

The satellite coverage information may be determined by the network side according to ephemeris information of a satellite.

If the UE receives the information of the update timer and the satellite coverage information, the update timer is started according to the information of the update timer. At the same time, when the update timer is started according to the information of the update timer and the update timer started at least once times out, whether to restart the update timer is determined according to the satellite coverage information.

In some examples, the information of the update timer, the satellite coverage information, and the indication information may be received together, for example, the information may be carried in the same NAS message sent to the UE by a first network element. This NAS message includes, but is not limited to, a registration request response message and/or a service request response message.

In some other examples, the information of the update timer, the satellite coverage information, and the indication information may be received by the UE from different messages sent by the first network element.
S210 may include that: a first value of a timing duration of the update timer is determined according to the satellite coverage information; and
the update timer is determined to be restarted according to the first value.

In the example of the disclosure, the first value is determined according to the satellite coverage information. With the first value so set, when the restarted update timer times out again, satellite signal coverage exists in the area where the UE is located. Then when the restarted update timer times out again, a registration update request may be sent to the network side by the UE based on a satellite signal.

By setting the first value, the number of times of restarting the update timer by the UE may be reduced. “First” in the “first value” here is merely used for distinguishing different temporary values, not specifically, so the “first value” may also be referred to as a “temporary value.”

For example, the first value is greater than or equal to: a duration of an interval between a current moment of the update timer and a start moment for that the satellite signal coverage exists again in the area where the UE is located.

For another example, the first value is smaller than: a duration of an interval between a current moment of the update timer and a start moment for that there is no satellite signal coverage again in the area where the UE is located.

If the first value meets the above requirements, when the update timer restarted by the UE times out again, the satellite signal coverage exists in the area where the UE is located, which is convenient for the UE to initiate a registration update request to the network, and successful initiation of the registration update process is ensured.

In some examples, the method further includes that:
the update timer is stopped, and the timing duration equal to the first value is restored to the second value in response to determining that the update timer times out and the satellite signal coverage exists in the area where the UE is located.

If the update timer is restarted according to the first value, when the restarted update timer times out, the timing duration of the update timer is restored to an original value (i.e., the second value) indicated by the information of the update timer sent by the network side, so that the UE may conveniently perform timing according to the original value (i.e., the second value) of the timing duration indicated by the information of the update timer during a period when satellite signal coverage exists.

In some examples, the satellite coverage information includes at least one of:
information of a start moment and duration information for that the satellite signal coverage exists in the area where the UE is located;
information of a start moment and duration information for that there is no satellite signal coverage in the area where the UE is located;
information of the start moment and an end moment for that the satellite signal coverage exists in the area where the UE is located; or
information of the start moment and an end moment for that there is no satellite signal coverage in the area where the UE is located.

If the satellite coverage information indicates the information of the start moment and the duration information for that the satellite signal coverage exists in the area where the UE is located, a period with satellite signal coverage and a period without satellite signal coverage in the area where the UE is located may be determined by the UE during a period of satellite coverage.

If the satellite coverage information contains the information of the start moment and the duration information for that there is no satellite signal coverage, a period without satellite signal coverage in the area where the UE is located in one satellite coverage period may be determined, and a remaining period in the satellite coverage period is the period with satellite signal coverage.

For example, the one satellite coverage period may be one day or half a day, etc.

In some examples, the satellite coverage information contains information of the start moments and the end moments with satellite signal coverage and without satellite signal coverage, so that a period with satellite signal coverage or a period without satellite signal coverage in the area where the UE is located may be directly determined according to the information of the start moments and the end moments.

The information of the start moment and the end moment may include:
information for indicating the start moment; and
information for indicating the end moment.

In another example, restarting the update timer may include that: the update timer is restarted according to the second value of the timing duration of the update timer in response to determining that the satellite signal coverage result indicates there is no satellite signal coverage.

If the update timer is restarted according to the second value, the update timer may be restarted once or more times until the satellite signal coverage exists in the area where the UE is located at the moment of the update timer restarts. The second value here may be the original value of the update timer, and may be indicated by the information of the update timer sent by the network side.

In this way, the update timer may be restarted according to the second value in a case the first value is not determined, and the registration update can also be initiated by the UE when the satellite signal coverage exists.

As shown in FIG. 5A, an example of the disclosure provides a method for controlling a timer, performed by a first network element, including that:
S500: a satellite signal coverage result of an area where UE is located is determined according to satellite coverage information in response to determining that a mobile reachable timer times out; and
S600: whether to restart the mobile reachable timer is determined according to the satellite signal coverage result of the area where the UE is located.

The first network element may be a network element of a core network, and for example, the network element of the core network may be an AMF, etc.

A network side device configures an update timer for the UE, as well as a mobile reachable timer and an implicitly deregistered timer on a network side.

Mobile reachable timer: This timer is used on the network side to monitor whether a registration update process is periodically initiated by the UE. A duration of the mobile reachable timer is usually longer than a duration of a periodic registration update timer, and by default, the mobile reachable timer is 4 minutes longer than the periodic registration update timer.

Implicitly deregistered timer: when the mobile reachable timer expires, the implicitly deregistered timer needs to be stated by a network, and a value of the implicitly deregistered timer is usually 4 minutes longer than that of the mobile reachable timer.

Information of the update timer is provided to the UE by the network through a registration accept message. The update timer is applicable to all tracking areas (TAs) to which the UE is assigned. The information of the update timer is received and saved by the UE. After that, if a new value of the timing duration assigned to the timer by the network is received by the UE, the original value needs to be overwrited by the UE with the new value. The information of the other two timers is saved and used by the network.

When a state of the UE on the AMF changes to an idle state, i.e., when an access layer (NAS) connection to the UE is released, the mobile reachable timer is started to monitor whether a registration update is initiated by the UE. When the state of the UE on the AMF changes from the idle state to other state, i.e., when the NAS connection to the UE is restored, the mobile reachable timer is started.

After the mobile reachable timer expires and the registration update request of the UE is still not received, a subsequent network behavior is defined by the network itself, and a paging message is usually not sent to the UE by the network any longer.

When the mobile reachable timer expires, the network needs to start the implicitly deregistered timer. If the network restores the NAS signaling connection to the UE, the implicitly deregistered timer is stopped. If the UE does not contact the network before the implicitly deregistered timer expires, the network needs to implicitly deregister the UE.

If there is no satellite signal coverage in the area where the UE is located when the mobile reachable timer times out, the mobile reachable timer is restarted, rather than the implicitly deregistered timer is started after the mobile reachable timer is stopped. In addition, after the implicitly deregistered timer times out, unnecessary implicit de-registrations of the UE caused by the fact that the UE cannot contact the network due to there is no satellite signal coverage in the area where the UE is located are reduced, and thus false implicit de-registrations are reduced.

As shown in FIG. 5B, an example of the disclosure provides a method for controlling a timer, performed by a first network element, including that:
S510: a satellite signal coverage result of an area where UE is located is determined according to satellite coverage information in response to determining that a mobile reachable timer times out; and
S610: the mobile reachable timer is determined to be restarted in response to determining that the satellite signal coverage result indicates that there is no satellite signal coverage.

Here, restarting the mobile reachable timer may include at least one of:
a temporary value for restarting the mobile reachable timer is determined according to the satellite coverage information, and the mobile reachable timer is restarted according to the temporary value, where the temporary value may be a fourth value other than a third value of an original timing duration of the mobile reachable timer;
the mobile reachable timer is restarted according to the original value (i.e., the third value) of the mobile reachable timer; or
the mobile reachable timer is restarted according to a pre-agreed or negotiated restart duration value.

In short, there are a plurality of specific modes to start the mobile reachable timer, as long as it is ensured that the mobile reachable timer is not stopped, that is, it remains in an operating state.

As shown in FIG. 5C, an example of the disclosure provides a method for controlling a timer, performed by a first network element, including that:
S520: a satellite signal coverage result of an area where UE is located is determined according to satellite coverage information in response to determining that a mobile reachable timer times out; and
S620: the mobile reachable timer is determined to be stopped in response to determining that the satellite signal coverage result indicates that the satellite signal coverage exists, that is, the timing mobile reachable timer is not restarted.

In one example, if the mobile reachable timer times out, whether the satellite signal coverage exists is further determined by the first network element according to the satellite signal coverage result. If the satellite signal coverage exists, the mobile reachable timer is stopped, and an implicitly deregistered timer is started.

In the example of the disclosure, the mobile reachable timer is stopped not only because of a timeout of the mobile reachable timer itself but also because of whether the satellite signal coverage exists in the area where the UE is located. When the satellite signal coverage exists in the area where the UE is located and the mobile reachable timer itself times out, the mobile reachable timer is stopped, so as to reduce unnecessary de-registrations of the UE.

In some examples, the method further includes that:
information of an update timer and the satellite coverage information are sent to the UE;
where information of the update timer is used for determining a second value.

Before the mobile reachable timer is started, the information of the update timer and the satellite coverage information are together or separately sent to the UE by the first network element, which facilitates the UE to receive the information of the update timer and the satellite coverage information from the same network signaling or different network signaling.

In some examples, S610 may include that:
a fourth value of the timing duration of the mobile reachable timer is determined according to the satellite coverage information in response to determining that the satellite signal coverage result indicates there is no satellite signal coverage; and
the mobile reachable timer is determined to be restarted according to the fourth value.

In the example of the disclosure, the fourth value is greater than or equal to: a duration of an interval between a current moment of the mobile reachable timer and a start moment for that the satellite signal coverage exists again in the area where the UE is located.

For example, the fourth value is smaller than: a duration of an interval between a current moment of the mobile reachable timer and a start moment for that there is no satellite signal coverage again in the area where the UE is located.

If a temporary value (i.e., the fourth value) of the mobile reachable timer is determined according to the satellite coverage signal, it may be ensured that satellite signal coverage exists in the area where the UE is located when the restarted mobile reachable timer times out again.

In some examples, the method further includes that:
in response to determining that the mobile reachable timer times out and the satellite signal coverage exists in the area where the UE is located, the mobile reachable timer is stopped, and the timing duration is restored from the fourth value to a third value of the timing duration of the mobile reachable timer.

If the mobile reachable timer is restarted according to the fourth value, when the mobile reachable timer times out again, the timing duration of the mobile reachable timer stored by the first network element is restored to the original value, so that the mobile reachable timer is started according to the configured original value of the timing duration during a period when satellite signal coverage exists in the area where the UE is located.

In some examples, S610 may include that:
the mobile reachable timer is restarted according to the third value of the timing duration of the mobile reachable timer in response to determining that the satellite signal coverage result indicates there is no satellite signal coverage.

If the mobile reachable timer is started according to the original value, the mobile reachable timer may be restarted once or more times until the satellite signal coverage exists in the area where the UE is located when the restarted mobile reachable timer times out again.

In some examples, the satellite coverage information includes at least one of:
information of a start moment and duration information for that the satellite signal coverage exists in the area where the UE is located;
information of a start moment and duration information for that there is no satellite signal coverage in the area where the UE is located;
information of the start moment and an end moment for that the satellite signal coverage exists in the area where the UE is located; or
information of the start moment and an end moment for that there is no satellite signal coverage in the area where the UE is located.

If the satellite coverage information indicates the information of the start moment and the duration information for that the satellite signal coverage exists in the area where the UE is located, a period with satellite signal coverage and a period without satellite signal coverage in the area where the UE is located may be determined by the UE during a period of satellite coverage.

If the satellite coverage information contains the information of the start moment and the duration information for that there is no satellite signal coverage, a period without satellite signal coverage in the area where the UE is located in one satellite coverage period may be determined, and a remaining period in the satellite coverage period is the period with satellite signal coverage.

For example, the one satellite coverage period may be one day or half a day, etc.

In some examples, the satellite coverage information contains information of the start moments and the end moments with satellite signal coverage and without satellite signal coverage, so that a period with satellite signal coverage or a period without satellite signal coverage in the area where the UE is located may be directly determined according to the information of the start moments and the end moments.

The information of the start moment and the end moment may include:
information for indicating the start moment; and
information for indicating the end moment.

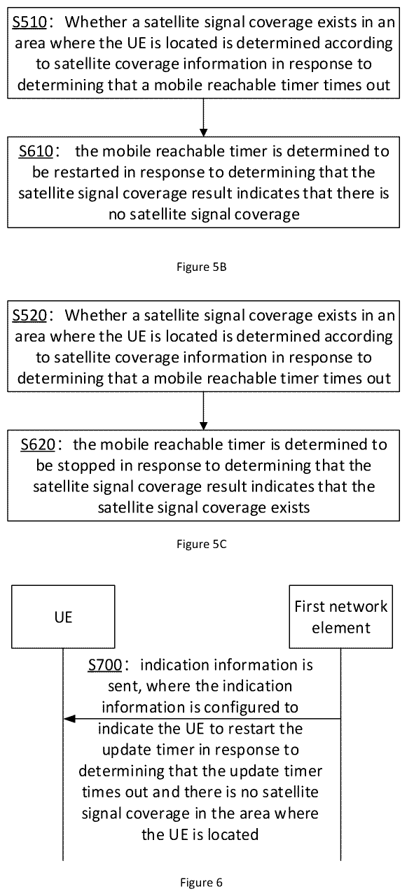

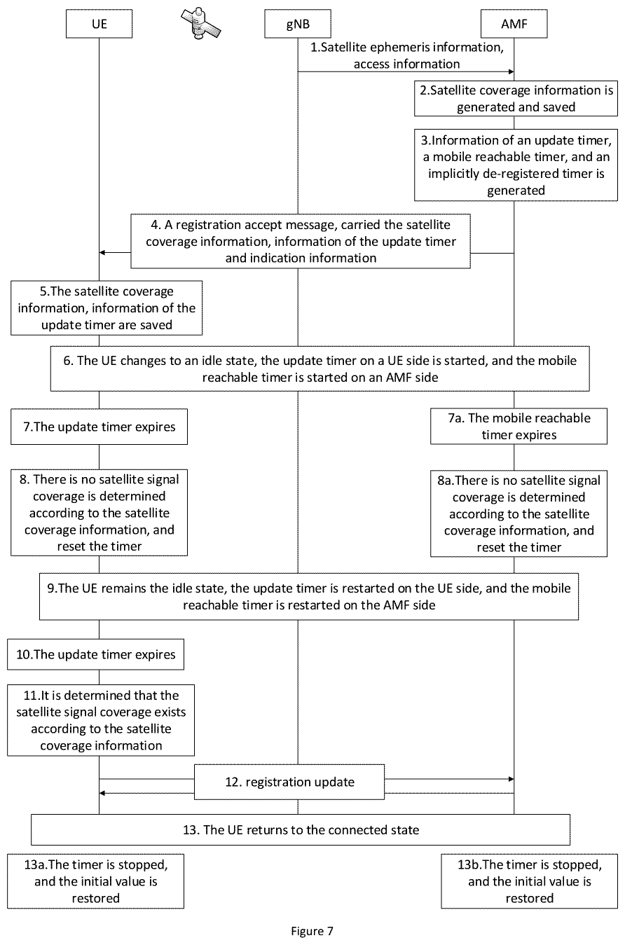

As shown in FIG. 6, an example of the disclosure provides an information processing method, performed by a first network element, including that:
S700: indication information is sent, where the indication information is configured to indicate the UE to restart the update timer in response to determining that the update timer times out and there is no satellite signal coverage in the area where the UE is located.

The information processing method may be performed alone or be performed in combination with any in above methods for controlling a timer performed by the first network element.

The indication information may be sent to the UE via any NAS message sent to the UE. For example, the indication information may be sent to the UE via a registration request response message or a service request response message.

The indication information is received by the UE. When the update timer of the UE times out and there is no satellite signal coverage in the area where the UE is located, the update timer is restarted. The operation of the update timer is stopped when the satellite signal coverage exists in the area where the UE is located, so as to reduce registration update processes caused by absent of satellite signal coverage, and thus failures of the registration update processes are reduced.

In some examples, the indication information indicates that:
if the update timer times out and there is no satellite signal coverage in the area where the UE is located, the UE is requested to determine the first value according to the satellite coverage information, and restart the update timer according to the first value;
or,
if the update timer times out and there is no satellite signal coverage in the area where the UE is located, the UE is requested to restart the update timer according to a second value of the update timer.

The specific mode in which the update timer of the UE is restarted may be indicated by the indication information.

Certainly, the above are merely examples of the indication information, which is not limited to the above examples during specific implementations.

In the related art, the condition of discontinuous coverage of the network is not taken into account in periodic registration updates of the UE. For example, when the periodic registration update timer expires, the registration update is initiated by the UE, and there is just no satellite signal coverage in the area where the UE is located, the periodic registration update cannot be successful in this case. On the contrary, since the UE needs to perform the registration update, cells that can be accessed are constantly searches for, so energy consumption of the UE is greatly increased. In addition, for the network side, according to the related art, if a registration update request of the UE is not received within specified time, the UE is implicitly deregistered by the network, but in this case, the de-registration does not occur on a UE side, it is because a terminal cannot interact with the network without network coverage.

Thus, in a process of executing periodic registration updates, the UE needs to formulate a reasonable trigger mechanism for periodic registration updates in combination with a condition of the discontinuous coverage of the network, so as to ensure that even when the UE reaches the conditions for initiating a periodic registration update, if the UE is in a state of without network coverage, the periodic registration update process is not initiated, so as to avoid causing useless energy consumption of the UE and shortening the working life of the UE.

The satellite coverage information is obtained and stored by the first network element, such as start time of coverage, a duration without signal coverage, and a duration with signal coverage for a specified area. The specified area is the area where the UE is located, for example, a TA or NTN cell where the UE is located.

The satellite coverage information is determined by the first network element according to satellite ephemeris information, UE access information (such as a UE access position, a UE registration TA list, etc.).

According to the satellite coverage information and UE access information, the time and duration for the UE with satellite signal coverage in a registration area, as well as the time and duration without satellite signal coverage, may be determined.

If the UE is successfully registered, a message containing the satellite coverage information and information of the periodic registration update timer is sent to the UE by the first network element. The message also contains indication information. The indication information is configured to instruct the UE that when the update timer expires, if there is no satellite signal coverage in the area where the UE is located, it is requested to update a temporary value according to the satellite coverage information, and the update timer is restarted according to the temporary value. The message may be a registration accept message, or a configuration update command.

The process of determining the temporary value of the update timer includes that:
a start moment when satellite signal coverage exists again is determined by the UE according to the satellite coverage information; and
the duration for restarting the update timer is set by the UE to be not less than a duration between the start moment when the satellite signal coverage exists again and the current moment.

The mobile reachable timer is set and saved by the first network element. When the mobile reachable timer is started and expires, whether the UE is in a period without satellite signal coverage at the moment is judged by the first network element according to the satellite coverage information.

If yes, according to the satellite coverage information, the temporary value of the mobile reachable timer is updated by the first network element, and the updated mobile reachable timer is restarted.

If not, the mobile reachable timer is stopped by the first network element, and an implicitly deregistered timer is started.

The process of determining the temporary value of the mobile reachable timer includes that:
a start moment when satellite signal coverage exists again is determined by the UE according to the satellite coverage information; and
a duration for the mobile reachable timer is set by the UE to be not less than a duration between the start moment when the satellite signal coverage exists again and the current moment.

When the periodic registration update timer of the UE and the mobile reachable timer on the network side are stopped, the duration of the timer is reset to a value before the temporary value.

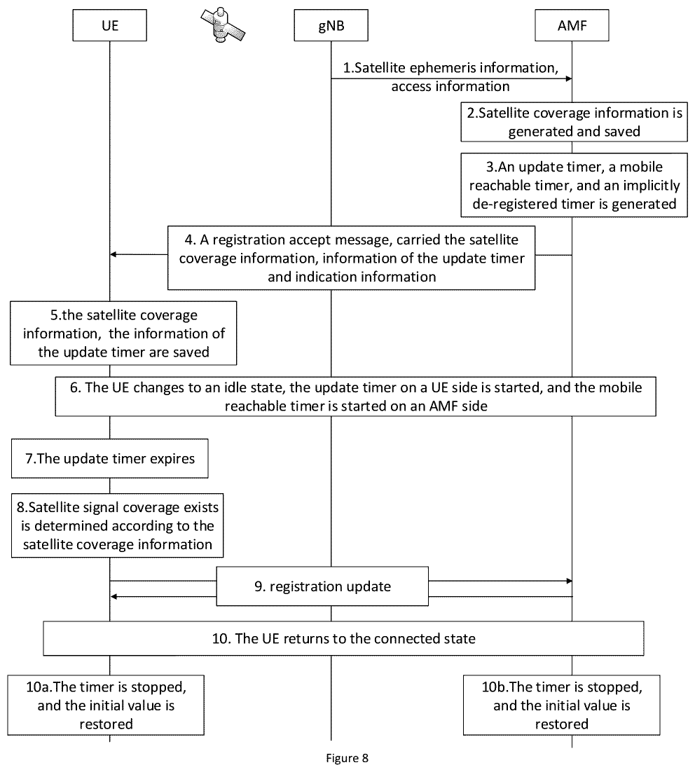

As shown in FIG. 7, an example of the disclosure provides a method which may include the following.

1. Satellite ephemeris information and access information are obtained by an AMF. The access information contains: user access position information. For example, the access information indicates through which TA UE accesses a network. The ephemeris information may be obtained by the AMF from gNB or configured on the network.

2. Satellite coverage information is generated and saved. Specifically, the satellite coverage information is determined by the AMF according to the above information and saved into a context of a user. According to the satellite coverage information, a start moment of satellite signal coverage of a satellite to a position of the user, a duration of satellite signal coverage, start time without satellite signal coverage, and/or a duration without satellite signal coverage may be obtained.

3. Information of an update timer, a mobile reachable timer, and an implicitly deregistered timer is generated. For example, a registration request of the UE is processed by the AMF. If a registration of the UE is accepted, the information of the update timer, the information of the mobile reachable timer, and the information of the implicitly deregistered timer for periodic registration updates are determined by the AMF. The information of the update timer at least indicates a timing duration of the update timer. The information of the mobile reachable timer at least indicates a timing duration of the mobile reachable timer. The information of the implicitly deregistered timer at least indicates a timing duration of the implicitly deregistered timer.

The information of the mobile reachable timer and the implicitly deregistered timer is saved by the AMF.

4. A registration accept message is sent to the UE by the AMF. The information of the update timer, the satellite coverage information, and indication information are carried by the registration accept message. The indication information is configured to indicate that when a registration update needs to be triggered by the UE, if there is no satellite signal coverage, a value of the update timer is determined, and the update timer is restarted.

5. The satellite coverage information, the information of the update timer, and/or the indication information, etc. are saved by the UE.

6. When the UE changes from other state (e.g., a connected state) to an idle state, the update timer on a UE side is started, and the mobile reachable timer is started on an AMF side.

7. The update timer on the UE side expires.

7a. The mobile reachable timer on the AMF side expires.

8. According to the satellite coverage information, it is determined that there is no satellite signal coverage in the area where the UE is located at this moment by the UE, and the UE still needs to remain in the idle state. According to the indication information, the update timer is set to a temporary value by the UE. Its value is not less than a duration between moment of the satellite signal coverage exists again and current moment, but less than a duration between moment for that there is no satellite signal coverage again and the current moment.

The mobile reachable timer on the AMF side will also expire, the mobile reachable timer also needs to be set to a temporary value by the AMF, and a setting mode is similar to that of the periodic registration update timer.

9. The UE remains the idle state, the update timer is restarted on the UE side, and the mobile reachable timer is restarted on the AMF side.

10. The update timer of the UE expires.

11. According to the satellite coverage information, it is determined that the satellite signal coverage exists in the area where the UE is located at the moment by the UE.

12. A periodic registration update request is initiated by the UE, and a process of a periodic registration update between the UE and the AMF is completed.

13a. The update timer is stopped by the UE, and the second value is restored.

13b. The mobile reachable timer is stopped by the AMF, and a third value of the timing duration of the mobile reachable timer is restored.

In short, an NAS connection between the UE and the AMF is restored, and the state of the UE returns to the connected state. The periodic registration update timer is stopped on the UE side, and an initial value before the temporary value is restored. The mobile reachable timer is stopped on the AMF side, and an initial value before the temporary value is restored.

If the UE in the connected state suddenly enters an area without satellite signal coverage, the UE changes from the connected state to the idle state at this time, and the update timer is started. If the update timer expires, and it is determined that there is no satellite signal coverage in an area where the UE is located by the UE according to the satellite coverage information, the update timer is reset according to the satellite coverage information. Similarly, if the AMF loses the NAS connection to the UE, the state of the UE changes to the idle state, and the mobile reachable timer is started. If the mobile reachable timer expires, and it is determined that there is no satellite signal coverage in the area where the UE is located by the AMF according to the satellite coverage information, the mobile reachable timer is reset according to the satellite coverage information.

It is worth noting that this solution is also applicable to a case when the UE in the connected state enters an area without satellite signal coverage.

As shown in FIG. 8, an example of the disclosure provides a method which may include the following.

1. Satellite ephemeris information and access information are obtained by an AMF. The access information contains: user access position information. For example, the access information indicates through which TA UE accesses a network. The ephemeris information may be obtained by the AMF from gNB or configured on the network.

2. Satellite coverage information is generated and saved. For example, the satellite coverage information is determined by the AMF according to the above information and saved into a context of a user. According to the satellite coverage information, a start moment of satellite signal coverage of a satellite to a position of the user, a duration of satellite signal coverage, start time without satellite signal coverage, and/or a duration without satellite signal coverage may be obtained.

3. A registration request of the UE is processed by the AMF. If a registration of the UE is accepted, the information of the update timer, the information of the mobile reachable timer, and the information of the implicitly deregistered timer for periodic registration updates are determined by the AMF. The information of the mobile reachable timer and the implicitly deregistered timer is saved by the AMF.

4. A registration accept message is sent to the UE by the AMF. The information of the update timer, the satellite coverage information, and indication information are carried by the registration accept message. The indication information is configured to indicate that when a registration update needs to be triggered by the UE, if there is no satellite signal coverage, a value of the update timer is determined, and the update timer is restarted.

5. The satellite coverage information, the information of the update timer, and/or the indication information, etc. are saved by the UE.

6. When the UE changes from other state (e.g., a connected state) to an idle state, the update timer on a UE side is started, and the mobile reachable timer is started on an AMF side.

7. The update timer on the UE side expires.

8. When the update timer on the UE side expires and a registration update request needs to be initiated, it is determined that there is no satellite signal coverage in the area where the UE is located at the moment according to the satellite coverage information by the UE.

9. A registration update request is initiated by the UE, and a process of a registration update between the UE and the network is completed.

10. After the registration update is successful, the state of the UE on the AMF and the UE changes to the connected state. A value of the periodic registration update timer on the UE side is reset, and the mobile reachable timer is stopped and reset on the AMF side.

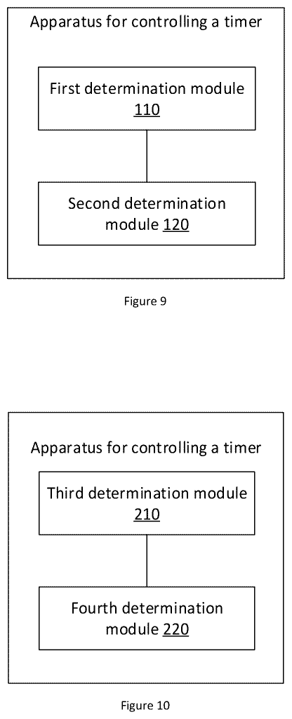

As shown in FIG. 9, an example of the disclosure provides an apparatus for controlling a timer, including:
a first determination module 110, configured to determine, according to satellite coverage information, a satellite signal coverage result of an area where UE is located in response to determining that an update timer times out; and
a second determination module 120, configured to determine, according to the satellite signal coverage result of the area where the UE is located, whether to restart the update timer.

The apparatus for controlling a timer is included in the UE which may be various types of terminals.

In some examples, the first determination module 110 and the second determination module 120 may be program modules. After the program modules are executed by a processor, the above operations can be implemented.

In some other examples, the first determination module 110 and the second determination module 120 may be software and hardware combined modules which include but are not limited to various programmable arrays. The programmable arrays include but are not limited to: a field programmable array and/or a complex programmable array.

In some other examples, the first determination module 110 and the second determination module 120 may be pure-hardware modules which include but are not limited to an application-specific integrated circuit.

In some examples, the second determination module 120 is configured to perform at least one of:
determining to restart the update timer in response to determining that the satellite signal coverage result indicates that there is no satellite signal coverage; or
determining to stop the update timer and initiate a registration update request in response to determining that the satellite signal coverage result indicates that the satellite signal coverage exists.

In some examples, the apparatus further includes:
a first reception module, configured to receive indication information, where the indication information is configured to indicate the UE to restart the update timer in response to that the update timer times out and there is no satellite signal coverage in the area where the UE is located, the update timer is restarted by the UE.

In some examples, the apparatus further includes:
a second reception module, further configured to receive information of the update timer and the satellite coverage information;
where the information of the update timer is used for determining a second value.

In some examples, the second determination module 120 is configured to determine, according to the satellite coverage information, a first value of a timing duration of the update timer; and determine to restart, according to the first value, the update timer.

In some examples, the first value is greater than or equal to: a duration of an interval between a current moment of the update timer and a start moment for that the satellite signal coverage exists again in the area where the UE is located.

In some examples, the apparatus further includes:
a first stop module, configured to stop the update timer and restore the timing duration from the first value to a second value in response to determining that the update timer times out and the satellite signal coverage exists in the area where the UE is located.

In some examples, the second determination module 120 is configured to start, according to the second value of the timing duration of the update timer, the update timer in response to determining that the satellite signal coverage result indicates that there is no satellite signal coverage.

In some examples, the satellite coverage information includes at least one of:
information of a start moment and duration information for that the satellite signal coverage exists in the area where the UE is located;
information of a start moment and duration information for that there is no satellite signal coverage in the area where the UE is located;
information of the start moment and an end moment for that the satellite signal coverage exists in the area where the UE is located; or
information of the start moment and an end moment for that there is no satellite signal coverage in the area where the UE is located.

As shown in FIG. 10, an example of the disclosure provides an apparatus for controlling a timer, including:
a third determination module 210, configured to determine, according to satellite coverage information, whether there is no satellite signal coverage in an area where UE is located in response to determining that a mobile reachable timer times out; and
a fourth determination module 220, configured to determine, according to a satellite signal coverage result of the area where the UE is located, whether to restart the mobile reachable timer.

The apparatus for controlling a timer may be included in a first network element.

The first network element includes, but is not limited to, an AMF.

In some examples, the third determination module 210 and the fourth determination module 220 may be program modules. After the program modules are executed by a processor, the above operations can be implemented.

In some other examples, the third determination module 210 and the fourth determination module 220 may be software and hardware combined modules which include but are not limited to: various programmable arrays. The programmable arrays include but are not limited to: a field programmable array and/or a complex programmable array.

In some other examples, the third determination module 210 and the fourth determination module 220 may be pure-hardware modules which include but are not limited to an application-specific integrated circuit.

In some examples, the third determination module 210 is configured to execute at least one of:
determining to restart the mobile reachable timer in response to determining that the satellite signal coverage result indicates that there is no satellite signal coverage; or
determining to stop the mobile reachable timer in response to determining that the satellite signal coverage result indicates that the satellite signal coverage exists.

In some examples, the apparatus further includes:
a first sending module, configured to send information of an update timer and the satellite coverage information to the UE;
where the information of the update timer is used for determining a second value of the update timer.

In some examples, the fourth determination module 220 is configured to determine, according to the satellite coverage information, a fourth value of a timing duration of the mobile reachable timer in response to determining that the satellite signal coverage result indicates there is no satellite signal coverage; and the mobile reachable timer is determined to be restarted according to the fourth value.

In some examples, the fourth value is greater than or equal to: a duration of an interval between a current moment of the mobile reachable timer and a start moment for that the satellite signal coverage exists again in the area where the UE is located.

In some examples, the apparatus further includes:

a second stop module, configured, to stop the mobile reachable timer and restore the timing duration from the fourth value to a third value of the timing duration of the mobile reachable timer in response to determining that the mobile reachable timer times out and there is the satellite signal coverage in the area where the UE is located.

In some examples, the fourth determination module 220 is configured to restart, according to the third value of the timing duration of the mobile reachable timer, the mobile reachable timer in response to determining that the satellite signal coverage result indicates there is no satellite signal coverage.

In some examples, the satellite coverage information includes at least one of:
information of a start moment and duration information for that the satellite signal coverage exists in the area where the UE is located;
information of a start moment and duration information for that there is no satellite signal coverage in the area where the UE is located;
information of the start moment and an end moment for that the satellite signal coverage exists in the area where the UE is located; or
information of the start moment and an end moment for that there is no satellite signal coverage in the area where the UE is located.

In some examples, the apparatus further includes:
a second sending module, configured to send indication information, where the indication information is configured to instruct the UE to restart the update timer in response to determining that the update timer times out and there is no satellite signal coverage in the area where the UE is located.

In some examples, the indication information indicates that:
if the update timer times out and there is no satellite signal coverage in the area where the UE is located, the UE is requested to determine the first value according to the satellite coverage information, and restart the update timer according to the first value;
or,
if the update timer times out and there is no satellite signal coverage in the area where the UE is located, the UE is requested to restart the update timer according to a second value of the update timer.

An example of the disclosure provides a communication device, including:
a memory configured to store processor executable instructions; and
a processor, connected with the memory.

The processor is configured to execute the method for controlling a timer and/or information processing method provided by any of the above technical solutions, such as the method provided by any one of FIG. 2A to FIG. 2C, FIG. 3 to FIG. 4, FIG. 5A to FIG. 5C, and/or FIG. 6 to FIG. 8.

The processor may include storage media of various types. The storage media are non-temporary computer storage media, and can continue to memorize information stored on it after a communication device is powered down.

Here, the communication device includes: an access device or UE or a first network element.

The processor may be connected with the memory via a bus and the like, and is configured to read the executable program stored on the memory, such as the method provided by any one of FIG. 2A to FIG. 2C, FIG. 3 to FIG. 4, FIG. 5A to FIG. 5C, and/or FIG. 6 to FIG. 8.

FIG. 11 is a block diagram of UE 800 illustrated according to an example. For example, the UE 800 may be a mobile phone, a computer, digital broadcasting user equipment, a messaging device, a game console, a tablet device, a medical device, a fitness device, a personal digital assistant, etc.

Referring to FIG. 11, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the UE 800, such as operations associated with display, telephone call, data communication, camera operations, and recording operations. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of these data include instructions for any application or method operating on the UE 800, contact data, phonebook data, messages, pictures, videos, etc. The memory 804 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 806 provides power for various components of the UE 800. The power component 806 may include a power management system, one or more power sources and other components associated with generating, managing and distributing power for the UE 800.

The multimedia component 808 includes a screen providing an output interface between the UE 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding and gestures on the touch panel. The touch sensor not only sense the boundary of the touch or sliding operation, but also detect the duration and pressure related to the touch or sliding operation. In some examples, the multimedia component 808 includes a front camera and/or a rear camera. When the UE 800 is in an operation mode, such as a shooting mode or a video mode, the front camera and/or the rear camera can receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the UE 800 is in the operation mode, such as a call mode, a recording mode, and a speech recognition mode. The received audio signal may be further stored in the memory 804 or transmitted via the communication component 816. In some examples, the audio component 810 further includes a speaker for outputting an audio signal.

The I/O interface 812 provides an interface between the processing component 802 and a peripheral interface module which may be a keyboard, a click wheel, a button, etc. These buttons may include but are not limited to: a home button, a volume button, a start button and a lock button.

The sensor component 814 includes one or more sensors for providing state evaluation of various aspects of the UE 800. For example, the sensor component 814 can detect an on/off state of the UE 800 and the relative positioning of the components, for example, the component is a display and a keypad of the UE 800. The sensor component 814 can further detect the change of the position of the UE 800 or one component of the UE 800, the presence or absence of user contact with the UE 800, the azimuth or acceleration/deceleration of the UE 800, and temperature change of the UE 800. The sensor component 814 may include a proximity sensor configured to detect the presence of nearby objects without any physical contact. The sensor component 814 may further include an optical sensor, such as a CMOS or CCD image sensor, for use in imaging applications. In some examples, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G or 3G, or their combination. In an example, the communication component 816 receives a broadcast signal or broadcast-related information from an external broadcast management system via a broadcast channel. In an example, the communication component 816 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the UE 800 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements for performing the above method.

In an example, a non-temporary computer-readable storage medium including instructions, such as the memory 804 including instructions, which can be executed by the processor 820 of the UE 800 to complete the above method, is further provided. For example, the non-temporary computer-readable storage medium may be an ROM, a random access memory (RAM), a CD-ROM, a magnetic tape, a floppy disk, an optical data storage device, etc.

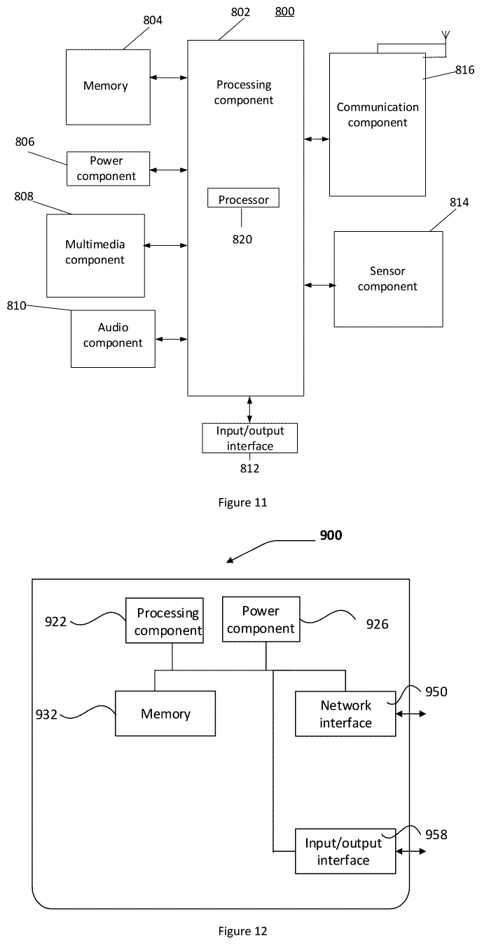

As shown in FIG. 12, an example of the disclosure shows a structure of a communication device. For example, the communication device may be provided as the first network element above. The communication device may be the access device and/or core network device above.

Referring to FIG. 12, the communication device 900 includes a processing component 922, which further includes one or more processors, and a memory resource represented by a memory 932 for storing instructions, such as applications, that can be executed by the processing component 922. The applications stored in the memory 932 may include one or more modules each corresponding to a set of instructions. In addition, the processing component 922 is configured to execute instructions to execute the methods above to implement above methods performed by the UE or by the first network element, specifically the method provided by any one of FIG. 2A to FIG. 2C, FIG. 3 to FIG. 4, FIG. 5A to FIG. 5C, and/or FIG. 6 to FIG. 8.

The communication device 900 may further include a power component 926 configured to perform power management of the communication device 900, a wired or wireless network interface 950 configured to connect the communication device 900 to the network, and an input/output (I/O) interface 958. The communication device 900 can operate an operating system based on the memory 932, such as Windows Server™, Mac OS X™, Unix™, Linux™, FreeBSD™, or the like.

Other implementations of the disclosure will be apparent to those skilled in the art from consideration of the specification and practice of the disclosure here. The disclosure is intended to cover any variations, uses, or adaptations of the disclosure that follow the general principles of the disclosure and include common knowledge or customary technical means in the technical field not disclosed here. It is intended that the specification and examples be considered as exemplary merely, with a true scope and spirit of the disclosure being indicated by the following claims.

It is to be understood that the disclosure is not limited to the exact construction that has been described above and illustrated in the accompanying drawings, and that various modifications and changes may be made without departing from its scope. The scope of the disclosure is merely limited by the appended claims.

1. A method for controlling an update timer, performed by a user equipment (UE), the method comprising:
determining, according to satellite coverage information, a satellite signal coverage result of an area where the UE is located in response to determining that an update timer times out; and
determining, according to the satellite signal coverage result of the area where the UE is located, whether to restart the update timer.

2. The method according to claim 1, wherein determining, according to the satellite signal coverage result of the area where the UE is located, whether to restart the update timer comprises at least one of:
determining to restart the update timer in response to determining that the satellite signal coverage result indicates that there is no satellite signal coverage; or
determining to stop the update timer and initiate a registration update request in response to determining that the satellite signal coverage result indicates that the satellite signal coverage exists.

3. The method according to claim 1, further comprising:
receiving indication information, wherein the indication information instructs the UE to restart the update timer in response to determining that the update timer times out and the satellite signal coverage result indicates that there is no satellite signal coverage.

4. The method according to claim 3, wherein determining to restart the update timer in response to determining that satellite signal coverage result indicates that there is no satellite signal coverage, comprises:
determining, according to the satellite coverage information, a first value of a timing duration of the update timer in response to determining that the satellite signal coverage result indicates that there is no satellite signal coverage; and
determining to restart, according to the first value, the update timer.

5. The method according to claim 3, wherein a first value is greater than or equal to: a duration of an interval between a current moment of the update timer and a start moment for that the satellite signal coverage exists again in the area where the UE is located.

6. The method according to claim 4, further comprising:
stopping the update timer and restoring the timing duration from the first value to a second value in response to determining that the satellite signal coverage result indicates that the satellite signal coverage exists.

7. The method according to claim 2, wherein determining to restart the update timer in response to determining that the satellite signal coverage result indicates there is no satellite signal coverage, comprises:
restarting, according to a second value of a timing duration of the update timer, the update timer in response to determining that the satellite signal coverage result indicates there is no satellite signal coverage.

8. The method according to claim 1, further comprising:
receiving information of the update timer and the satellite coverage information;
wherein the information of the update timer is configured to determine that a timing duration of the update timer is a second value.

9. The method according to claim 1, wherein the satellite coverage information comprises at least one of:
information of a start moment and duration information for that the satellite signal coverage exists in the area where the UE is located;
information of the start moment and the duration information for that there is no satellite signal coverage in the area where the UE is located;
information of the start moment and an end moment for that the satellite signal coverage exists in the area where the UE is located; or
information of the start moment and the end moment for that there is no satellite signal coverage in the area where the UE is located.

10. A method for controlling a mobile reachable timer, performed by a first network element, the method comprising:
determining, according to satellite coverage information, a satellite signal coverage result of an area where UE is located in response to determining that a mobile reachable timer times out; and
determining, according to the satellite signal coverage result of the area where the UE is located, whether to restart the mobile reachable timer.

11. The method according to claim 10, wherein determining, according to the satellite signal coverage result of the area where the UE is located, whether to restart the mobile reachable timer comprises at least one of:
determining to restart the mobile reachable timer in response to determining that the satellite signal coverage result indicates that there is no satellite signal coverage; or
determining to stop the mobile reachable timer in response to determining that the satellite signal coverage result indicates that the satellite signal coverage exists.

12. The method according to claim 10, further comprising:
sending information of an update timer and the satellite coverage information to the UE;
wherein the information of the update timer is configured to determine that a timing duration of the update timer is a second value.

13. The method according to claim 10, wherein determining to restart the mobile reachable timer in response to determining that the satellite signal coverage result indicates there is no satellite signal coverage comprises:
determining, according to the satellite coverage information, a fourth value of a timing duration of the mobile reachable timer in response to determining that the satellite signal coverage result indicates there is no satellite signal coverage; and
determining to restart, according to the fourth value, the mobile reachable timer.

14. The method according to claim 13, wherein the fourth value is greater than or equal to: a duration of an interval between a current moment of the mobile reachable timer and a start moment for that the satellite signal coverage exists again in the area where the UE is located.

15. The method according to claim 13, further comprising:
stopping the mobile reachable timer, and restoring the timing duration from the fourth value to a third value in response to determining that the satellite signal coverage result indicates that the satellite signal coverage exists.

16. The method according to claim 11, wherein determining to restart the mobile reachable timer in response to determining that the satellite signal coverage result indicates there is no satellite signal coverage, comprises:
restarting, according to a third value of a timing duration of the mobile reachable timer, the mobile reachable timer in response to determining that the satellite signal coverage result indicates there is no satellite signal coverage.

17. The method according to claim 10, wherein the satellite coverage information comprises at least one of:
information of a start moment and duration information for that the satellite signal coverage exists in the area where the UE is located;
information of the start moment and the duration information for that there is no satellite signal coverage in the area where the UE is located;
information of the start moment and an end moment for that the satellite signal coverage exists in the area where the UE is located; or
information of the start moment and the end moment for that there is no satellite signal coverage in the area where the UE is located.

18. The method according to claim 10, further comprising:
sending indication information, wherein the indication information instructs the UE to restart the update timer in response to determining that the update timer times out and the satellite signal coverage result indicates that there is no satellite signal coverage.

19.-20. (canceled)

21. A communication device, comprising:
a processor,
a transceiver,
a memory, and
an executable program stored on the memory and capable of being operated by the processor, wherein when the executable program is executed by the processor, causes the communication device to:
determines, according to satellite coverage information, a satellite signal coverage result of an area where the communication device is located in response to determining that an update timer times out; and
determines, according to the satellite signal coverage result of the area where the communication device is located, whether to restart an update timer.

22. (canceled)

23. A communication device, comprising
a processor,
a transceiver,
a memory, and
an executable program stored on the memory,
wherein the executable program, when executed by the processor causes the communication device to perform the method according to claim 10.
